(19) United States
(12) Patent Application Publication
(10) Pub. No.: US 2018/0355646 A1
(43) Pub. Date: Dec. 13, 2018

(54) VEHICLE HOOD HINGE

(71) Applicant: Flex-N-Gate Advanced Product Development, LLC, Warren, MI (US)

(72) Inventors: Peter Revelis, Newmarket (CA); Sarabit Singh, Mississauga (CA); Brent Brockerville, Toronto (CA); Jaafar Bashiry - Khoshraftar, Richmond Hill (CA)

(21) Appl. No.: 16/002,667

(22) Filed: Jun. 7, 2018

Related U.S. Application Data
(60) Provisional application No. 62/516,838, filed on Jun. 8, 2017.

(51) Int. Cl. E05D 5/06; B62D 25/12; B62D 65/06; E05D 3/02; E05D 5/12

(52) U.S. Cl. CPC E05D 5/062; B62D 25/12; B62D 65/06; E05Y 2900/536; E05D 5/121; E05D 2005/122; E05D 3/02

(57) ABSTRACT

A hinge assembly having a first bracket mountable to a hood or a body component and having a flange with an opening; a second bracket mountable to the other of the hood and the body component and having a flange with an opening; a bushing coupled to the first bracket and having a base disposed in the opening of the first bracket and defining a bore; a spacer, which includes a base having a first side with a knurl and a second opposite side, a shoulder extending from the second side into the bore, and a through hole extending through the base and the shoulder; a fastener having a head and a threaded shank extending from the head through the opening in the second bracket and the through hole in the spacer; and a nut threaded to the threaded shank with an end surface of the nut contacting the knurl.

### CROSS-REFERENCE TO RELATED APPLICATIONS

This application claims the benefit of and priority to U.S. Provisional Patent Application No. 62/516,838, which was filed on Jun. 8, 2017. The foregoing U.S. application is incorporated by reference herein in its entirety.

### BACKGROUND

The present application relates generally to the field of hinge assemblies for vehicles. More specifically, this application relates to the field of hinge assemblies for use with hoods of vehicles.

### SUMMARY

At least one embodiment of this application relates to a hinge assembly for rotatably coupling a hood of a vehicle to a body component of the vehicle. The hinge assembly includes a first bracket, a second bracket, a bushing, a spacer, a fastener, and a nut. The first bracket is mountable to one of the hood and the body component, and the first bracket has a flange with an opening therein. The second bracket is mountable to the other of the hood and the body component, and the second bracket has a flange with an opening therein. The bushing is coupled to the first bracket and has an annular base that is disposed in the opening of the first bracket and defines a bore. The spacer includes a base having a first side and a second opposite side, the first side comprising a knurl; a shoulder extending from the second side of the base into the bore toward the second bracket; and a through hole extending through the base and the shoulder. The fastener has a head and a threaded shank extending from the head through the opening in the second bracket and the through hole in the spacer. The nut threads to the threaded shank with an end surface of the nut contacting the knurl.

The end surface of the nut can include serrations that directly contact the knurl, such as to tailor the frictional force between the nut and the spacer. The hinge assembly can optionally include a washer disposed between the first bracket and the second bracket.

At least one embodiment of this application relates to a hinge assembly for rotatably coupling a hood of a vehicle to a body component of the vehicle. The hinge assembly includes a first bracket, a second bracket, a bushing, a spacer, a fastener, and a nut. The first bracket is mountable to one of the hood and the body component, and the first bracket has a flange with an opening therein. The second bracket is mountable to the other of the hood and the body component, and the second bracket has a flange with an opening therein. The bushing is coupled to the first bracket and has an annular base disposed within the opening of the first bracket and defines a bore. The spacer includes a base, a shoulder extending from the base into the bore toward the second bracket, and a through hole extending through the base and the shoulder. The fastener has a head and a threaded shank extending from the head through the opening in the second bracket and the through hole in the spacer. The nut threads to the threaded shank, such that serrations on an end surface of the nut contact a side of the base of the spacer that is opposite the shoulder.

The side of the base of the spacer contacting the nut can include a knurled portion that directly contacts the serrations of the end surface of the nut, such as to tailor the frictional force between the nut and the spacer. The hinge assembly can optionally include a washer disposed between the first bracket and the second bracket.

At least one embodiment of this application relates to a method of assembling a hinge assembly for a vehicle, which can, for example, be used to rotatably couple a vehicle hood of to a body component of the vehicle. The method includes coupling a bushing to a first bracket, so that a base of the bushing is located in an opening in a flange of the first bracket; providing a second bracket on a first side of the first bracket, so that an opening in a flange of the second bracket is aligned with a bore in the bushing; providing a spacer on a second side of the first bracket, so that a base of the spacer is proximate the second side, a shoulder of the spacer, which extends from the base, is located within the bore of the bushing, and a bore in the spacer is aligned with the opening in the flange of the second bracket; inserting a shank of a fastener into the opening in the flange of the second bracket and the bore in the spacer; and threading a nut to the shank to secure the second bracket, first bracket, bushing, and spacer between the nut and a head of the fastener; wherein a side of the base of the bushing contacts a surface of the nut, and the side of the base includes a knurl. When the hinge assembly is used to rotatably couple the hood to the body component, the first bracket is configured to couple to one of the hood and the body component, and the second bracket is configured to couple to the other of the hood and the body component.

### BRIEF DESCRIPTION OF THE DRAWINGS

FIG. 1 is an exploded perspective view of an exemplary embodiment of a hood hinge assembly, according to this application.

FIG. 2 is a cross-sectional view of the hood hinge assembly shown in FIG. 1.

FIG. 3 is a bottom perspective view of a nut, according to a first embodiment.

FIG. 4 is a top view of the nut shown in FIG. 3.

FIG. 5 is a side view of the nut shown in FIG. 3.

FIG. 6 is a bottom view of the nut shown in FIG. 3.

FIG. 7 is a bottom view of a spacer.

FIG. 8 is a top view of the spacer shown in FIG. 7 after adding a through hole, according to a first embodiment.

FIG. 9 is a side view of the spacer shown in FIG. 8.

FIG. 10 is a top perspective view of a hinge bracket and a bushing.

FIG. 11 is a side perspective view of a hinge bracket, a bushing, and a spacer.

FIG. 12 is a perspective view of a hinge bracket, a bushing, and a spacer.

FIG. 13 is a perspective view of a washer.

FIG. 14 is a graph containing data.

FIG. 15 is another graph containing data.

FIG. 16 is another graph containing data.

FIG. 17 is the cross-sectional view of the hood hinge assembly shown in FIG. 2.

FIG. 18 is a side view of a spacer.

FIG. 19 is a side view of a spacer.

FIG. 20 is a top perspective view of a nut, according to a second embodiment.

FIG. 21 is a top perspective view of a spacer, according to a second embodiment.

### DETAILED DESCRIPTION

Referring generally to the FIGURES, disclosed herein are hinge assemblies for use in vehicles (e.g., motor vehicles, electric vehicles, hybrid vehicles, etc.). The hinge assemblies are configured to better control the prevailing torque on the nut, an interface of the nut (e.g., a spacer), and a fastener (e.g., a bolt, a screw, etc.) engaging the nut to resist loosening during use of the hinge assembly and the vehicle with the hinge assembly. One problem with current hinge assemblies is that they tend to loosen over time, which means that the effort to move the hood through the hinge assembly may change over the life of the vehicle. Trying to control the prevailing torque through manufacturing processes and checks (e.g., at the end of the assembly line) are expensive and cumbersome. Therefore, it would be beneficial to provide an assembly that can control the prevailing torque without the need for the additional processes and checks, which would reduce the assembly cost and assembly time while also reducing or eliminating the loosening problem over the life of the product.

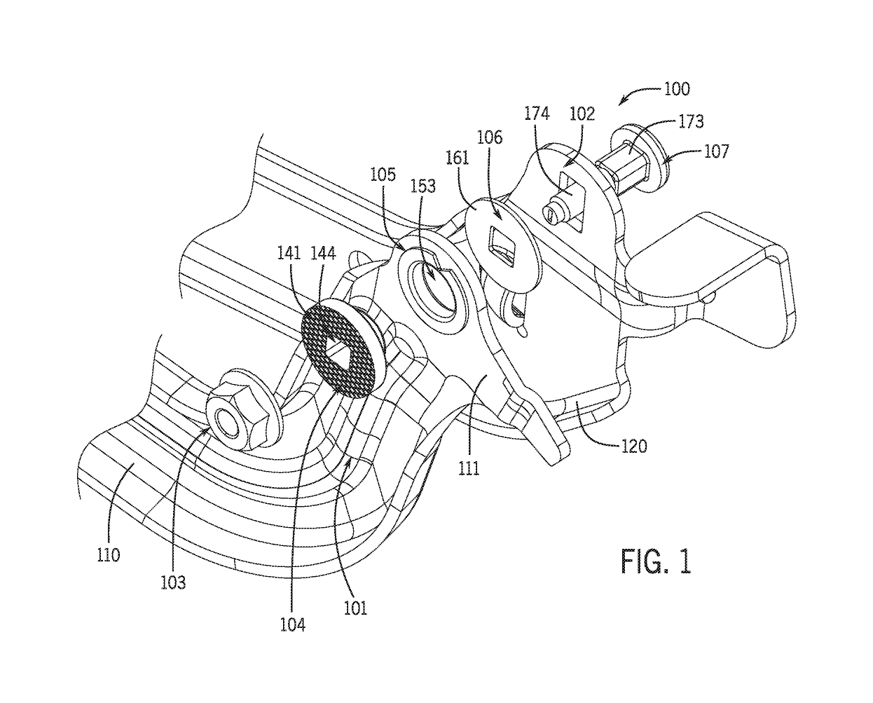

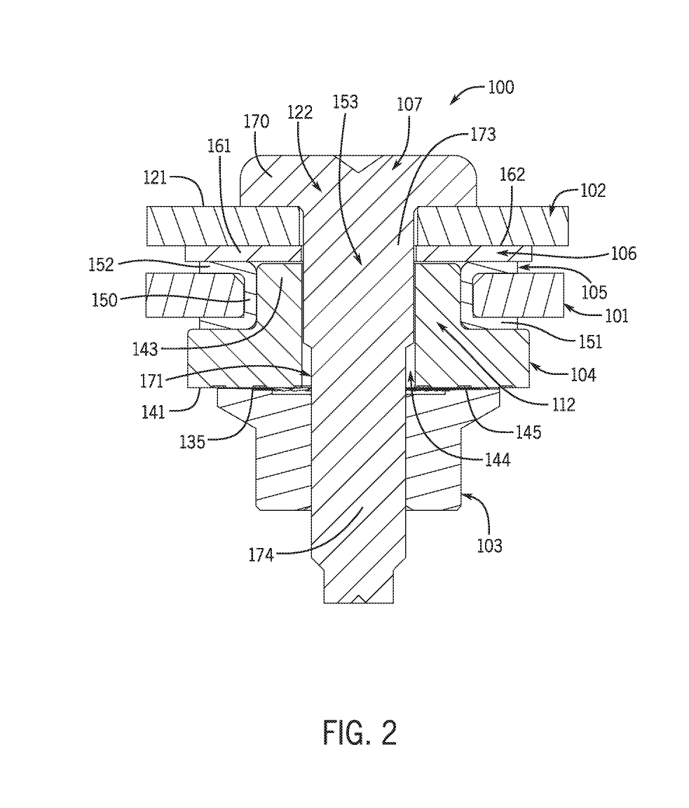

FIGS. 1 and 2 illustrate an exemplary embodiment of a hinge assembly 100, which can be used to rotatably mount a first bracket relative to a second bracket. One non-limiting example of an exemplary application of the hinge assembly 100 is for use with hoods (e.g., hood assemblies) of vehicles, where the first bracket is mounted to the hood and the second bracket is mounted to another component of the vehicle (e.g., a body component) to allow the hood to rotate relative to the other component. It is noted that the hinge assemblies disclosed herein can be used in other vehicle applications, such as door hinge assemblies, trunk hinge assemblies, tailgate hinge assemblies, etc.

As shown in FIGS. 1 and 2, the hinge assembly 100 includes a first bracket 101, a second bracket 102, a nut 103, a spacer 104, a bushing 105, a washer 106, and a fastener 107. It is noted that other embodiments of hinge assemblies can include fewer or additional elements/components. By way of example, the washer 106 can be an optional component.

The first bracket 101 is mountable to a hood of the vehicle (e.g., vehicle hood) or another element/component of the vehicle, such as a body component of the vehicle. As shown in FIG. 1, the first bracket 101 is configured to mount to the hood. The first bracket 101 has a mounting feature, such as the illustrated base 110, and a flange 111, which extends from the base 110. The flange 111 includes an opening 112 therein, and the opening 112 is configured to receive the bushing 105, as discussed below in more detail. The opening 112 in the first bracket 101 is illustrated in FIG. 1 as having a circular shape that extends through the entire thickness of the flange 111. However, the opening 112 in the first bracket 101 can be configured to have other suitable shapes.

The second bracket 102 is mountable to the other of the hood and another element/component of the vehicle, such as a body component of the vehicle. As shown in FIG. 1, the second bracket 102 is configured to mount to a body component of the vehicle, which remains stationary when the hood and the first bracket 101 are moved (e.g., pivoted) between open and closed positions. The second bracket 102 has a mounting feature, such as the illustrated base 120, and a flange 121, which extends from the base 120. The flange 121 includes an opening 122 therein, and the opening 122 is configured to receive the fastener 107, as discussed below in more detail. The opening 122 in the second bracket 102 is illustrated in FIG. 2 as having a generally square shape (e.g., square, square with rounded corners, etc.) that extends through the entire thickness of the flange 121. The generally square shaped opening 122 in the flange 121 is configured (e.g., acts) as an anti-rotation feature to prevent relative rotation between the fastener 107 and the second bracket 102. It is noted that the opening 122 in the second bracket 102 can be configured to have other suitable shapes (e.g., generally rectangular, D-shaped, double D-shaped, star shaped, splined, etc.) that would provide anti-rotation between the fastener 107 and the second bracket 102.

The bushing 105 is coupled to the first bracket 101 and configured to receive the spacer 104. As shown best in FIG. 2, the bushing 105 includes an annular base 150, a first wall 151 extending from a first end of the annular base 150, and a second wall 152 extending from a second end of the annular base 150, which is opposite the first end of the annular base 150. Accordingly, the bushing 105 can have a C-shaped or U-shaped cross-section, such as after assembly to the first bracket 101. Also shown in FIG. 2, the first bracket 101 is nested in the bushing 105, with the first wall 151 extending along a first side of the flange 111, the second wall 152 extending along a second side of the flange 111, and the annular base 150 disposed in (e.g., within, inside of, etc.) the opening 112 of the first bracket 101. The annular base 150 of the bushing 105 defines a bore 153, which is shown in FIG. 1 as having a circular shape. The bore 153 of the bushing 105 is configured to receive the spacer 104, as discussed below in more detail. The bushing 105 is configured to facilitate rotation, such as between the first bracket 101 and the spacer 104, which can be keyed to the second bracket 102. The bushing 105 can include a material (e.g., polytetrafluoroethylene (PTFE)) that reduces the coefficient of friction between the elements/components of the hinge assembly 100 (e.g., spacer 104, first bracket 101, etc.).

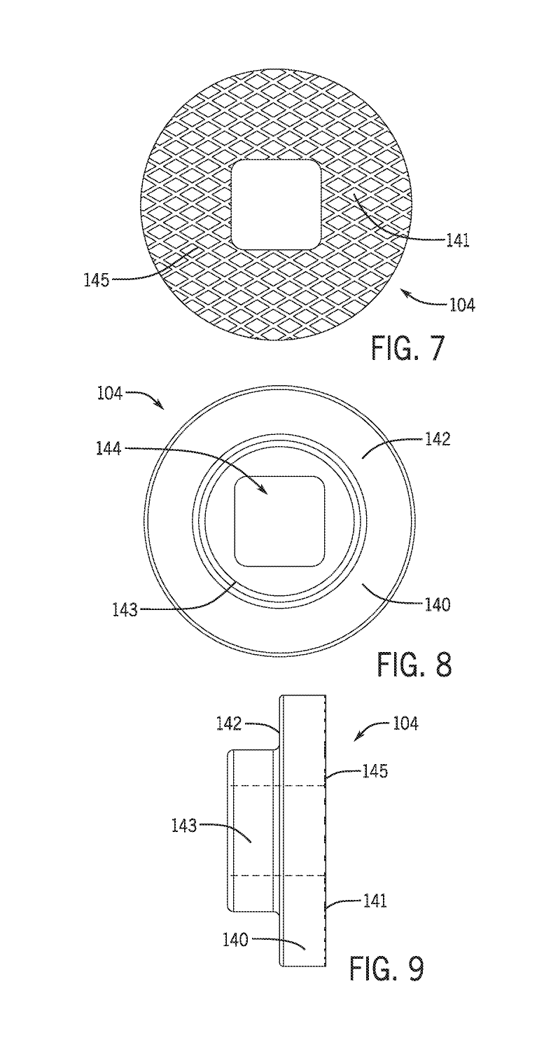

As shown in FIGS. 1 and 2, the spacer 104 is configured to engage the bushing 105 and receive the fastener 107. FIGS. 7-9 illustrate a spacer 104 according to an exemplary embodiment. As shown, the spacer 104 includes a base 140 having a first side 141 and a second side 142 opposite the first side 141. The spacer 104 also includes a shoulder 143 extending from the second side 142 of the base 140. The shoulder 143 is configured to engage the bushing 105 and, accordingly, the size and shape of the shoulder 143 can be tailored to the arrangement of the bushing 105. As shown, the shoulder 143 has an outer diameter that complements the bore 153 of the bushing 105 such that the shoulder 143 can be inserted into the bore 153. The fit between the bushing 105 and the shoulder 143 of the spacer 104 can be designed for a press-fit condition (e.g., including an interference fit). It is noted that the term “interference fit” as used herein includes a male part (e.g., the shoulder) having a larger outer size (e.g., diameter, width, etc.) than the receiving female part (e.g., the bore 153 in the bushing 105) so that material (e.g., of the male part, of the female part, of both parts) is deformed (e.g., elastically, plastically) during assembly (e.g., insertion) to couple the two parts together. The base 140 of the spacer 104 can have a larger size (e.g., diameter) than the shoulder 143 such that at least a portion of the second side 142 of the base 140 that is radially outward from the shoulder 143 can contact the first wall 151 of the bushing 105 (see FIG. 2). For example, an outer radial size (e.g., diameter, width across flats, etc.) of the shoulder 143 can be less than an outer radial size of the base 140.

The spacer 104 can include a friction element for controlling the prevailing torque. For example, the first side 141 of the spacer 104 shown in FIGS. 7-9 includes a friction element 145 that is configured to control the prevailing torque between the spacer 104 and the nut 103 when the nut 103 is coupled (e.g., threaded) to the fastener 107 and in contact with the spacer 104, which is considered to be a secured position (e.g., of the nut 103, the hinge assembly, etc.), to resist loosening of the hinge assembly 100 over its life. One non-limiting example of the friction element 145 of the spacer 104 is a knurling (e.g., knurl, knurled portion, etc.), which can be applied to the entire first side 141 or a portion thereof. For example, a knurling having a surface roughness (Rₐ) in the range of from three (3) micrometers (μm) up to (and including) six (6) micrometers (μm) can be applied to the first side 141 of the spacer 104. The knurling in the first side 141 can be of any suitable design (e.g., crossed pattern, straight pattern, curved pattern, etc.). Other types of friction elements 145, such as serrations, dimples, projections, etc. can be employed with the spacer 104. The friction element 145 of the spacer 104 can be employed alone or in combination with a friction element of the nut 103, as discussed below in more detail.

The spacer 104 includes a through hole 144 that extends through the base 140 and the shoulder 143. The through hole 144 is configured to receive the fastener 107 and can be tailored to complement the shape of the fastener 107. As shown in FIGS. 1 and 8, the through hole 144 is generally square shaped. The generally square shaped through hole 144 of the spacer 104 is configured as an anti-rotation feature to prevent relative rotation between the fastener 107 and the spacer 104. It is noted that the through hole 144 can be configured to have other suitable shapes (e.g., generally rectangular, D-shaped, double D-shaped, star shaped, splined, etc.) that would provide anti-rotation between the fastener 107 and the spacer 104.

The fastener 107 extends through the second bracket 102 and the spacer 104 to couple to the nut 103 to secure the hinge assembly 100 together. As shown in FIGS. 1 and 2, the fastener 107 includes a head 170 and a shank 171 extending from the head 170 in a longitudinal direction. The head 170 is larger in size (e.g., cross-sectional area) than the shank 171 in order contact a portion of the second bracket 102, as shown in FIG. 2. The head 170 clamps the second bracket 102 to the other elements/components (e.g., the spacer 104, the bushing 105, the first bracket 101, the washer 106, if provided). The shank 171 includes a first portion 173, which is coupled to the head 170, and a second portion 174 that extends from the first portion 173 in the longitudinal direction away from the head 170. As shown best in FIG. 2, the first portion 173 of the shank 171 extends through the opening 122 in the second bracket 102 and the through hole 144 in the spacer 104.

The first portion 173 of the shank 171 is configured as an anti-rotation feature to prevent relative rotation between the fastener 107 and the second bracket 102, as well as between the fastener 107 and the spacer 104. Accordingly, the fastener 107, the second bracket, and the spacer 104 remain stationary together as the first bracket 101 rotates with the hood relative to these elements or these elements rotate together relative to the first bracket 101 (e.g., if coupled to the body component). As shown best in FIG. 1, the first portion 173 of the shank 171 is generally square shaped, such as to complement the generally square shaped opening 122 in the flange 121 of the second bracket 102 and/or to complement the generally square shaped through hole 144 in the spacer 104. It is noted that the first portion 173 of the shank 171 can be configured to have other suitable shapes (e.g., generally rectangular, D-shaped, double D-shaped, star shaped, splined, etc.) that would provide anti-rotation between the fastener 107 and the second bracket 102 and/or the spacer 104.

The second portion 174 of the shank 171 extends from the first portion 173 in a direction away from the head 170. The second portion 174 includes external threads that thread to internal threads of the nut 103. The second portion 174 can include a lead-in feature (e.g., fillet, chamfer, etc.) that makes assembly easier.

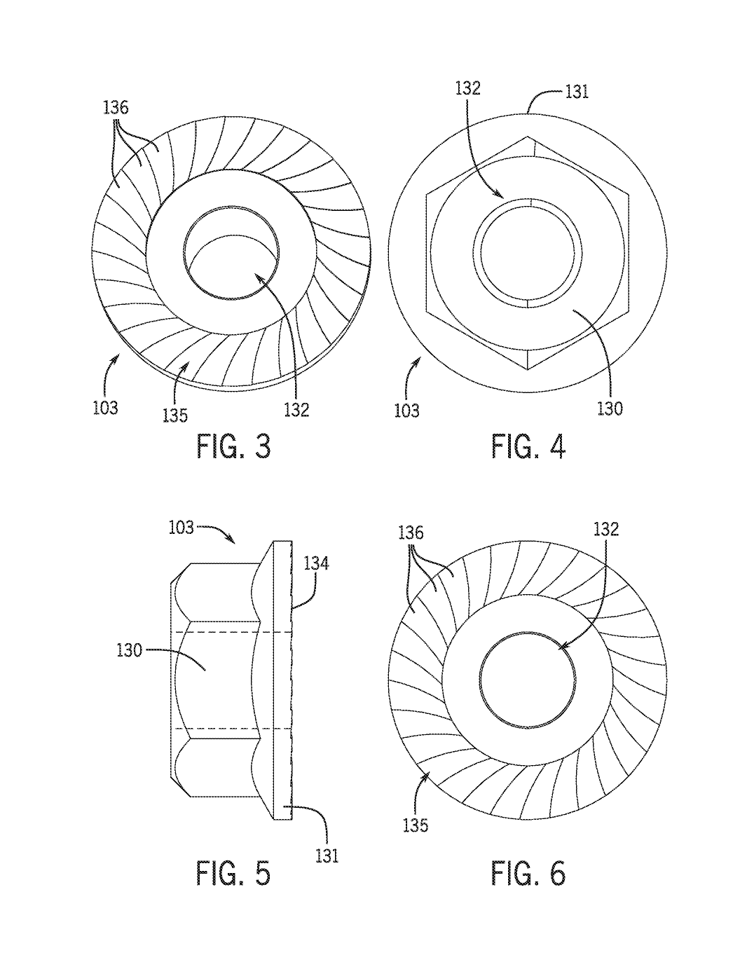

As shown in FIGS. 1 and 2, the nut 103 threads to the fastener 107, such as to the shank 171 or a portion thereof (e.g., the second portion 174), to secure the hinge assembly 100 together by retaining the elements of the assembly between the nut 103 and the head 170 of the fastener 107. As shown in FIGS. 3-6, the nut 103 is configured as a hex nut having a six-sided head 130 to allow a user to turn the nut using a conventional tool (e.g., wrench, socket, etc.). Also shown, the nut 103 has a flange 131 disposed on one side of the head 130. The flange 131 can have a larger size (e.g., diameter) than the head 130, such as to increase the area retained and/or the friction/clamp force imparted by the nut 103. The nut 103 also includes a threaded opening 132 configured to thread to the fastener 107.

As shown best in FIGS. 3 and 6, the flange 131 of the nut 103 includes a friction element 135 (e.g., one or more serrations 136) for controlling the prevailing torque. According to an exemplary embodiment, the side 134 of the flange 131 opposite the head 130 includes a friction element 135 that is configured to control the prevailing torque between the spacer 104 and the nut 103 when the nut 103 is coupled to the fastener 107 to resist loosening of the hinge assembly 100 over its life. One non-limiting example of the friction element 135 of the nut 103 includes a plurality of serrations 136 extending away from the side 134. As shown in FIGS. 3 and 6, the plurality of serrations 136 is arranged circumferentially around the opening 132 on the side 134 of the flange 131. Another non-limiting example of the friction element 135 of the nut 103 includes a knurling, which can be applied to the side 134 or a portion thereof. For example, such a knurling can have a surface roughness (Ra) of between three (3) and six (6) micrometers (μm) when applied to the side 134 of the nut 103. The knurling in the side 134 can be of any suitable design (e.g., crossed pattern, straight pattern, curved pattern, etc.). Other types of friction elements 135, such as dimples, projections, a combination of friction elements, etc. can be employed with the nut 103. The friction element 135 of the nut 103 can be employed alone or, according to another example, in combination with a friction element of the spacer 104 as discussed herein.

The hinge assembly 100 can include one or more than one washer. As shown in FIGS. 1 and 2, a washer 106 is disposed between the second bracket 102 and the first bracket 101. The washer 106 has a first side 161 that faces or abuts the first bracket 101, the bushing 105, and/or the spacer 104, and also has a second side 162 that faces or abuts the second bracket 102. As shown in FIG. 2, the first side 161 of the washer 106 contacts the bushing 105 and the spacer 104 upon clamping the assembly together (e.g., tightening the nut 103 over the fastener 107), and the second side 162 of the washer 106 contacts the second bracket 102 upon clamping the assembly together. It is noted that the washer 106 is optional, and that the assembly could employ no washers or a plurality of washers.

An exemplary method of assembling the hinge assembly 100 will now be described. The bushing 105 is coupled to the first bracket 101, then the fastener 107 is inserted through the opening 122 in the second bracket 102, an opening in the washer 106 (if provided), and the through hole 144 in the spacer 104, which is inserted into the bushing 105. Then the nut 103 is threaded to the fastener 107, such as, for example, until a predetermined torque is obtained, clamping the spacer 104, the first bracket 101, the bushing 105, and the second bracket 102 between the nut 103 and the fastener 107.

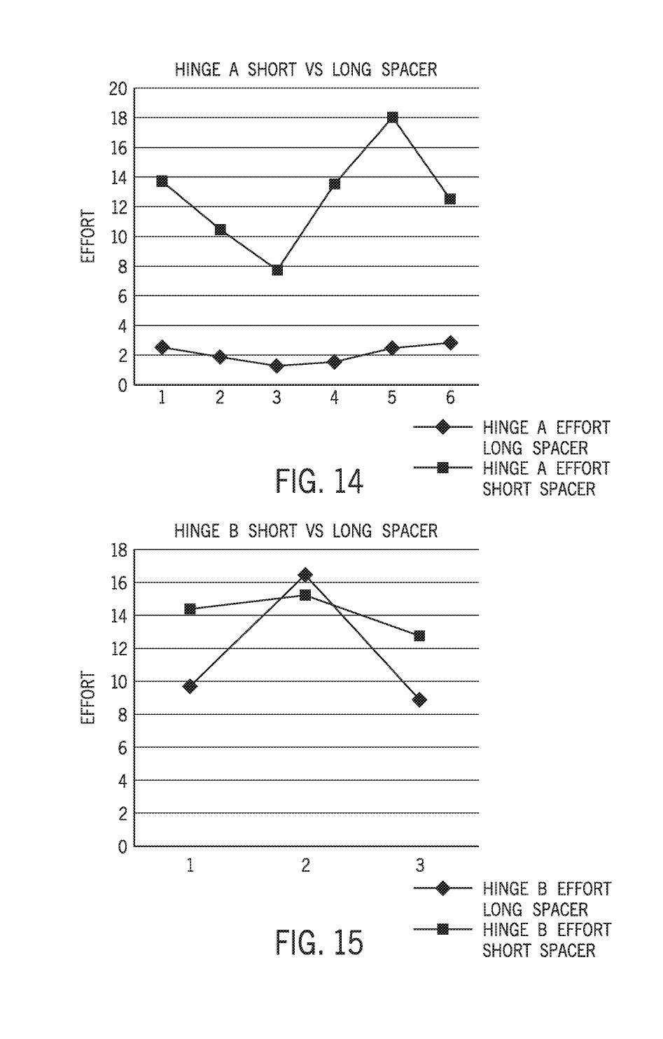

As noted above, the use of the one or more friction elements on the nut 103 and/or the spacer 104 control the prevailing torque holding the assembly together. Thus, the interface between the nut 103, the spacer 104, and the fastener 107 better resist loosening during use of the hinge assembly and the vehicle with the hinge assembly. This is evidenced by the data provided in FIGS. 14-20, which includes effort data, tolerance stack-up data, and durability (e.g., cycle) data.

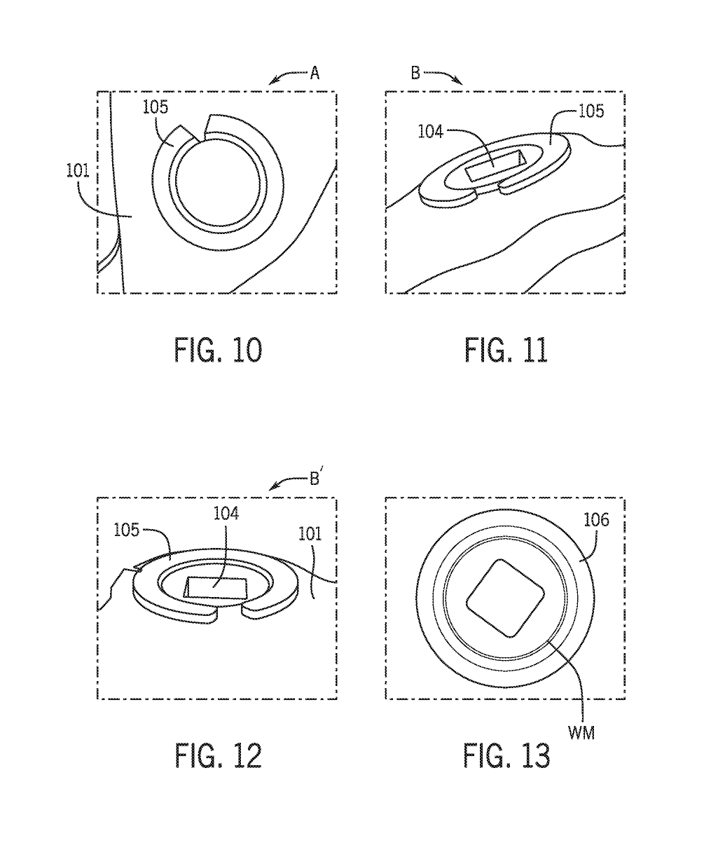

FIGS. 14 and 15 are graphs showing effort data of test samples comparing different configurations. FIG. 14 compares effort data of six samples of hinge A design, as shown in FIG. 10, having a short spacer (e.g., see the spacer 104 shown in FIG. 12 with hinge B′ design) with effort data of six samples of hinge A design having a long spacer (e.g., see the spacer 104 shown in FIG. 11 with hinge B design). The average effort for the hinge A design samples having short spacers is 12.67 N compared with the average effort for the hinge A design samples having long spacers is 2.05 N. FIG. 15 compares the effort data of three samples of hinge B design having a long spacer 104 (FIG. 11) with effort data of three samples of hinge B′ design having a short spacer 104 (FIG. 12). The average effort for the hinge B′ design having short spacers is 14.20 N compared with the average effort for the hinge B design having long spacers is 11.77 N. As shown in FIG. 11, a long spacer 104 is configured to extend at least to an outer surface of the bushing 105. Thus, the end of the long spacer 104 is flush with or extends beyond the bushing 105. As shown in FIG. 12, a short spacer 104 is configured to be recessed within the outer surface of the bushing 105. Thus, the end of the short spacer 104 is short of (e.g., recessed inside) the bushing 105. FIG. 13 illustrates a washer 106 with a witness mark WM applied by a long spacer 104 during cycling/testing. With reference to FIG. 2, a long spacer 104 contacts part of the washer 106, if provided, increasing the friction between the spacer 104 and the washer 106 while reducing the friction between the spacer 104 and the bushing 105 as the clearance between the spacer 104 and bushing 105 increases. These differences in design lead to the changes in effort.

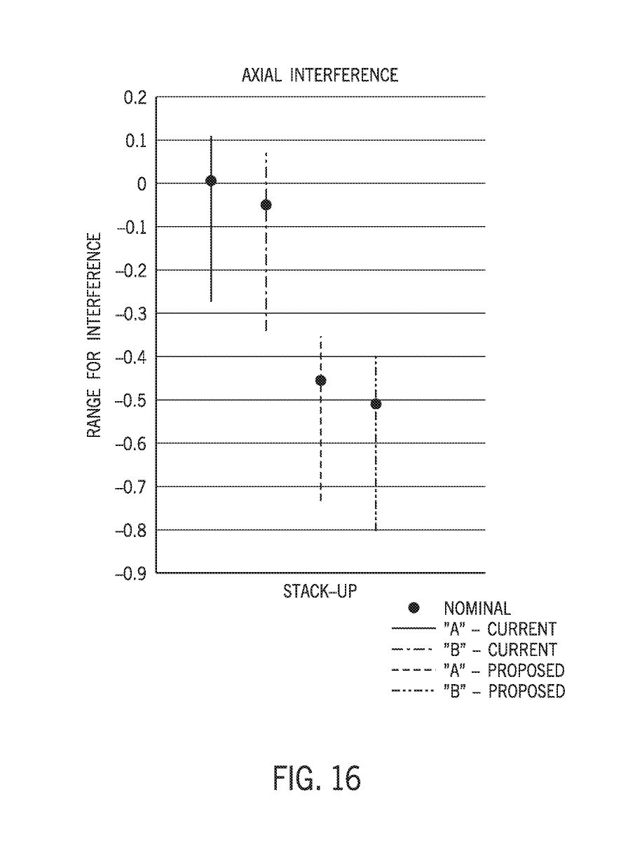

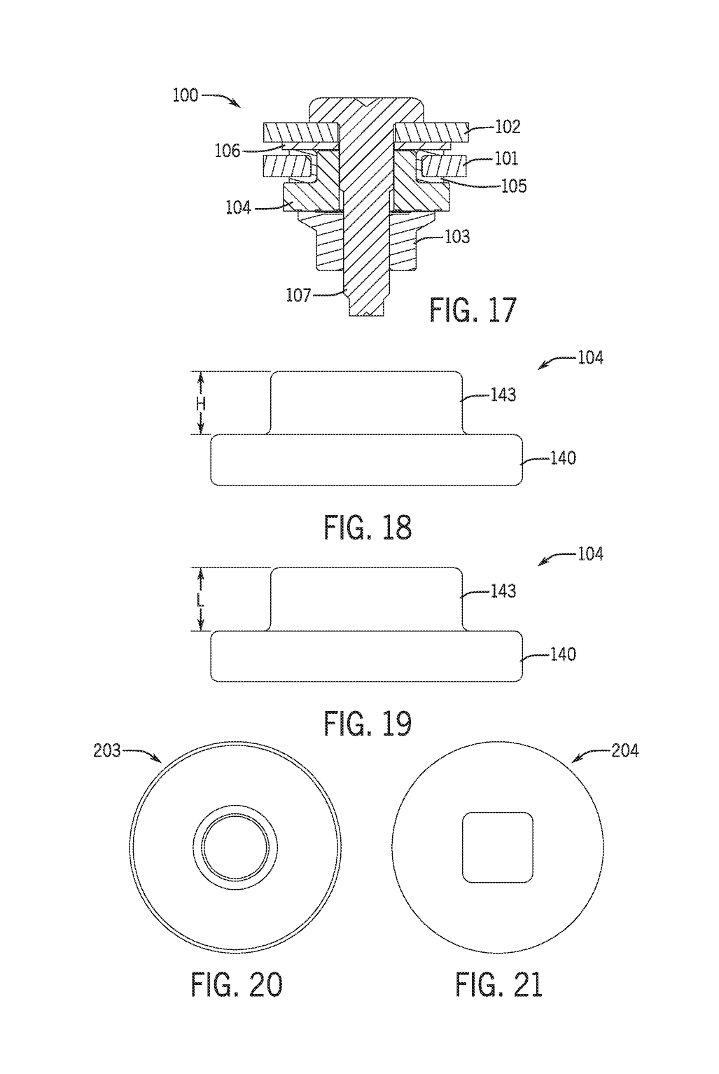

FIGS. 16-19 illustrate a tolerance stack aimed at reducing the axial interference (shown schematically in FIG. 17) by shortening a length of a shoulder 143 from a base 140 of a spacer 104 from a high H±0.5 (e.g., high dimension H±0.5 mm), as shown in FIG. 18 (also see FIG. 11), to a low L±0.5 (e.g., low dimension L±0.5 mm), as shown in FIG. 19 (also see FIG. 12). The hinge assembly 100 illustrated in FIG. 17 includes a first bracket 101, a second bracket 102, a nut 103, a spacer 104, a bushing 105, a washer 106, and a fastener 107. As shown in FIG. 16, the changes in the spacer 104 (e.g., shortening of the length of the shoulder 143 from the base 140) lead to a shift in the range of the axial interference. The reduction (e.g., shortening) of the spacer 104 results in changes in effort data of the hinge assembly, such as the data shown in FIGS. 14 and 15.

Testing was performed comparing effort data after a number of cycles that is expected to simulate a vehicle life (e.g., 12000 cycles) between a hinge having no friction elements on the spacer 204 (e.g., no knurling), as shown in FIG. 21, and the nut 203 (e.g., no serrations), as shown in FIG. 20, and a hinge having frictions elements on the spacer (e.g., knurling) and the nut (e.g., serrations), such as the hinge assembly 100 having the spacer 104 and the nut 103. The effort (e.g., torque) for the hinge without friction elements after a vehicle life was well below the specification, which is defined as a range from a lower specification limit (LSL) up to and including an upper specification limit (USL), whereas the effort for the hinge with friction elements after a vehicle life was in the middle of the specification. Further, the hinge without friction elements began to back off (e.g., have an effort reduction) after only 10 cycles, whereas the hinge with friction elements did not back off even after a vehicle life. Accordingly, the data (e.g., test data) supports that the hinge having friction elements better controls the prevailing torque on the hinge (e.g., nut, fastener, spacer, etc.) without the need for additional processes and checks.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining can be stationary (e.g., permanent) or moveable (e.g., removable or releasable). Such joining can be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the hood hinge assemblies as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Other substitutions, modifications, changes and omissions may also be made in the design, operating conditions and arrangement of the various exemplary embodiments without departing from the scope of the present invention. For example, any element (e.g., brackets, spacers, nuts, fasteners, bushings, etc.) disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A hinge assembly for a vehicle, the hinge assembly comprising:
a first bracket configured to mount to one of a vehicle hood and a vehicle body component, the first bracket having a flange with an opening therein;
a second bracket configured to mount to the other of the vehicle hood and the vehicle body component, the second bracket having a flange with an opening therein;
a bushing coupled to the first bracket and having an annular base, which is disposed in the opening of the first bracket and defines a bore;
a spacer comprising:
a base having a first side and a second opposite side, the first side comprising a knurl;
a shoulder extending from the second side of the base of the spacer into the bore in the bushing toward the second bracket; and
a through hole extending through the base of the spacer and the shoulder;
a fastener having a head and a threaded shank extending from the head through the opening in the second bracket and the through hole in the spacer; and
a nut threaded to the threaded shank with an end surface of the nut contacting the knurl.

2. The hinge assembly of claim 1, wherein the end surface of the nut has serrations that contact the knurl in a secured position of the nut.

3. The hinge assembly of claim 2, wherein a shape of the shoulder complements a shape of the bore in the bushing, and an outer radial size of the shoulder is less than an outer radial size of the base of the spacer.

4. The hinge assembly of claim 2, wherein the shoulder has an interference fit with the bushing, and an outer radial size of the shoulder is less than an outer radial size of the base of the spacer.

5. The hinge assembly of claim 1, further comprising a washer disposed between the first bracket and the second bracket.

6. The hinge assembly of claim 5, wherein the bushing includes a wall extending from the annular base and located between the first bracket and the second bracket.

7. The hinge assembly of claim 6, wherein the wall of the bushing is a first wall that extends from a first end of the annular base, the bushing includes a second wall that extends from a second end of the annular base, and the first bracket is located between the first and second walls of the bushing.

8. The hinge assembly of claim 7, further comprising at least one of the vehicle hood and the vehicle body component, wherein the second wall of the bushing contacts the second side of the base of the spacer.

9. The hinge assembly of claim 1, wherein the knurl has a surface roughness ranging from three micrometers up to and including six micrometers.

10. A hinge assembly for a vehicle, the hinge assembly comprising:
a first bracket configured to mount to one of a vehicle hood and a vehicle body component, the first bracket having a flange with an opening therein;
a second bracket configured to mount to the other of the vehicle hood and the vehicle body component, the second bracket having a flange with an opening therein;
a bushing coupled to the first bracket and having an annular base disposed within the opening of the first bracket and defining a bore;
a spacer comprising a base, a shoulder extending from the base of the spacer into the bore toward the second bracket, and a through hole extending through the base and the shoulder of the spacer;
a fastener having a head and a shank extending from the head through the opening in the second bracket and the through hole in the spacer; and
a nut threaded to threads on the shank, such that serrations on an end surface of the nut contact a side of the base of the spacer that is opposite the shoulder.

11. The hinge assembly of claim 10, wherein the side of the base of the spacer contacting the nut has a knurled portion that contacts the serrations of the end surface of the nut in a secured position.

12. The hinge assembly of claim 11, wherein the knurled portion has a surface roughness ranging from three micrometers up to and including six micrometers.

13. The hinge assembly of claim 12, further comprising a washer disposed between the first bracket and the second bracket.

14. The hinge assembly of claim 13, wherein bushing comprises a first wall, which extends from a first end of the annular base, and a second wall, which extends from a second end of the annular base, wherein the first bracket is located between the first and second walls of the bushing, and wherein the first wall is disposed between the first bracket and the washer.

15. The hinge assembly of claim 10, wherein the shank of the fastener includes a first portion having an anti-rotation feature that prevents relative rotation between the fastener and the first bracket with the anti-rotation feature engaging the opening in the flange of the second bracket.

16. The hinge assembly of claim 15, further comprising the vehicle hood and the vehicle body component, wherein the shank of the fastener includes a second portion having the threads that thread to the nut.

17. A method of assembling a hinge assembly for a vehicle, comprising:
coupling a bushing to a first bracket, so that a base of the bushing is located in an opening in a flange of the first bracket;
providing a second bracket on a first side of the first bracket, so that an opening in a flange of the second bracket is aligned with a bore in the bushing;
providing a spacer on a second side of the first bracket, so that a base of the spacer is proximate the second side, a shoulder of the spacer, which extends from the base, is located within the bore of the bushing, and a bore in the spacer is aligned with the opening in the flange of the second bracket;
inserting a shank of a fastener into the opening in the flange of the second bracket and the bore in the spacer; and
threading a nut to the shank to secure the second bracket, first bracket, bushing, and spacer between the nut and a head of the fastener;
wherein a side of the base of the spacer contacts a surface of the nut, and the side of the base of the spacer includes a knurl.

18. The method of claim 17, wherein the surface of the nut includes serrations.

19. The method of claim 18, wherein coupling the bushing includes forming a first wall of the bushing onto a first side of the first bracket and forming a second wall of the bushing onto a second side of the first bracket, wherein the first wall extends from a first end of the base of the bushing, and wherein the second wall extends from a second end of the base of the bushing.

20. The method of claim 19, further comprising:
providing a washer between the second wall of the bushing and the second bracket; and
press-fitting the shoulder of the spacer into the bore of the bushing
wherein the first bracket is configured to couple to one of a vehicle hood and a vehicle body component of the vehicle, and the second bracket is configured to couple to the other of the vehicle hood and the vehicle body component.
